(19) United States
(12) Patent Application Publication
(10) Pub. No.: US 2016/0275407 A1
(43) Pub. Date: Sep. 22, 2016

(54) DIAGNOSTIC DEVICE, ESTIMATION METHOD, NON-TRANSITORY COMPUTER READABLE MEDIUM, AND DIAGNOSTIC SYSTEM

(71) Applicant: KABUSHIKI KAISHA TOSHIBA, Tokyo (JP)

(72) Inventors: Hideyuki AISU, Kawasaki (JP); Mikito Iwamasa, Tokyo (JP); Tomoshi Otsuki, Kawasaki (JP)

(21) Appl. No.: 15/067,682

(22) Filed: Mar. 11, 2016

(30) Foreign Application Priority Data
Mar. 20, 2015 (JP) 2015-058673

(51) Int. Cl. G06N 7/00

(52) U.S. Cl. CPC G06N 7/005

(57) ABSTRACT

An estimation device according to an aspect of the present invention includes an estimator and a selector. The estimator, for each of a plurality of times, estimates a probability density distribution of a parameter representing a state of a diagnosis object, based on a measurement value of the diagnosis object, the measurement value being measured up to each of the times. The selector selects one or more probability density distributions meeting a predetermined condition relating to the probability density distribution.

### CROSS-REFERENCE TO RELATED APPLICATION(S)

This application is based upon and claims the benefit of priority from Japanese Patent Application No. 2015-058673, filed Mar. 20, 2015; the entire contents of which are incorporated herein by reference.

### FIELD

An embodiment relates to a diagnostic device, an estimation method, non-transitory computer readable medium, and a diagnostic system.

### BACKGROUND

In order to prevent a decrease in operation rate of an installation, e.g., early detection of abnormalities, early identification of abnormal parts, detection of signs and the like are matters of great importance. In recent years, a movement of providing various services such as monitoring, control and diagnosis of installations by means of cloud services via the Internet has been active. In cloud services, monitoring is consistently performed using sensors or the like included in devices, enabling quick detection of abnormalities compared to conventional maintenance performed on site.

Also, in recent years, methods in which an abnormality in an installation or a sensor itself is estimated by means of data mining or a machine learning modeling have been disseminated. In machine learning modeling, normal data is learned based on measurement data in a normal state, and if data other than the normal data is detected, it is determined that a state is abnormal. Consequently, it is possible to not only quickly detect occurrence of an abnormality, but also detect a sign of an abnormality before the abnormality actually occurs.

However, as the scale of the system is larger, it is more difficult to identify a device causing deterioration or an abnormality even though as a sign of the deterioration or the abnormality can be detected in the entire system. In order to identify the device, it is necessary to set up a large number of high-performance sensors in, e.g., an installation, a space in which the installation is provided and the like, resulting increase in costs. With massive increase of measurement data, problems arise in, e.g., collection and storage of data and communication traffic increase. Also, there are few indicators for determining whether or not data has an abnormality, which causes the problem of lack of accuracy.

### BRIEF DESCRIPTION OF THE DRAWINGS

FIG. 1 is a block diagram illustrating an example of a schematic configuration of a diagnostic device according to an embodiment of the present invention;

FIG. 2 is a block diagram illustrating an example of a diagnostic device where a particle filter is used;

FIGS. 3A to 3E are diagrams illustrating a content of processing in a particle filter;

FIGS. 4A and 4B are diagrams each illustrating an example of an output;

FIG. 5 is a flowchart of processing relating to measurement data;

FIG. 6 is a flowchart of probability density distribution estimation and output processing;

FIG. 7 is a flowchart of particle filter processing;

FIG. 8 is a flowchart of probability density distribution search processing; and

FIG. 9 is a block diagram illustrating an example of a hardware configuration according to an embodiment of the present invention.

### DETAILED DESCRIPTION

An embodiment of the present invention detects and identifies an abnormality or deterioration in a diagnosis object.

An estimation device according to an aspect of the present invention includes an estimator and a selector.

The estimator, for each of a plurality of times, estimates a probability density distribution of a parameter representing a state of a diagnosis object, based on a measurement value of the diagnosis object, the measurement value being measured up to each of the times.

The selector selects one or more probability density distributions meeting a predetermined condition relating to the probability density distribution.

Below, a description is given of embodiments of the present invention with reference to the drawings. The present invention is not limited to the embodiments.

### First Embodiment

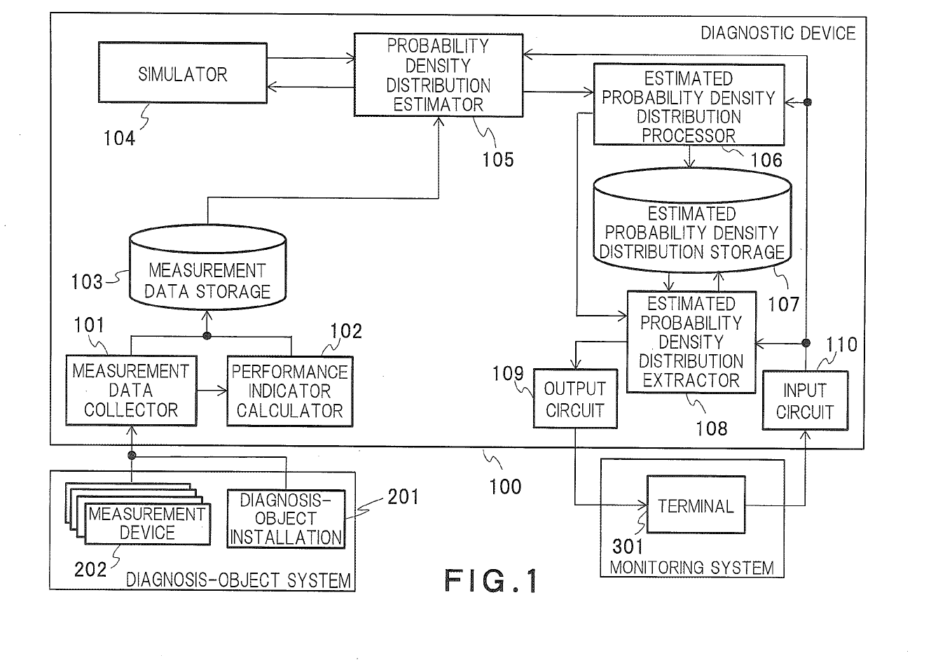

FIG. 1 is a block diagram illustrating an example of a schematic configuration of a diagnostic device according to an embodiment of the present invention. A diagnostic device 100 according to an embodiment of the present invention is connected to a diagnosis-object system in which a diagnosis-object installation exists and a monitoring system such as a monitoring center via a non-illustrated communication network. Transmission and reception of respective data are performed via the communication network. The communication network may be a wired network, a wireless network, a network that is a hybrid of a wired network and a wireless network.

In the diagnosis-object system, a diagnosis-object installation 201, and measurement devices 202 exist. The measurement devices 202 are such as sensors that monitor the installation. As the measurement devices 202, one or more measurement devices may be provided, and the measurement devices 202 may be directly attached to the installation or exist around the installation.

In the monitoring system, a terminal 301 exists. The terminal 301 is such as a PC that receives an output from the diagnostic device 100. Monitoring staff such as an operator determines, e.g., whether or not maintenance work is necessary, and a content of the maintenance work, based on the output.

The diagnostic device 100 includes a measurement data collector 101, a performance indicator calculator 102, a measurement data storage 103, a simulator 104, a probability density distribution estimator 105, an estimated probability density distribution processor 106, an estimated probability density distribution storage 107, an estimated probability density distribution extractor 108, an output circuit 109 and an input circuit 110.

The measurement data collector 101 collects measurement data from the diagnosis-object installation 201 and the measurement devices 202 monitoring the diagnosis object, via the communication network. One or more types of measurement items may be included in the measurement data. Also, data of a measurement item that is not necessary for diagnosis of the diagnostic device 100 does not need to be included.

The measurement data from the diagnosis-object installation 201 may be any data that can be measured by the diagnosis-object installation 201. For example, the measurement data may be a log of a set temperature, power consumption, control signals, errors or the like in the installation. Information on the diagnosis-object installation 201 may be received not only from the diagnosis-object installation 201, but also from a measurement device 202 attached to the diagnosis-object installation 201.

The measurement data from the measurement devices 202 may be any data that can be measured by the measurement devices 202. If the diagnosis-object installation 201 is an air-conditioning installation, examples of the measurement data include, e.g., temperatures and humidity of rooms, flow rates and temperatures of water flowing to/from heat exchangers and operation sounds of devices.

The measurement data may be acquired by the measurement data collector 101 at an arbitrary timing by means of polling. Or, the diagnosis-object installation 201 and the measurement devices 202 may transmit the measurement data to the measurement data collector 101 at respective arbitrary timings. The collected measurement data is send to the performance indicator calculator 102 and the measurement data storage 103.

The performance indicator calculator 102 calculates a performance indicator for the diagnosis-object installation 201 based on the measurement data acquired from the measurement data collector 101. The performance indicator represents performance of the diagnosis-object installation 201. For example, the performance indicator may be a heat amount calculated from a temperature and a flow rate in the case of an air-conditioning installation. Also, the performance indicator may be an accumulated power amount or a fuel consumption amount per day in the case of a power generation installation. The performance indicator may be any indicator that can be calculated based on the measurement data. The calculated performance indicator is sent to the measurement data storage 103.

The performance indicator is used for calculation of a later-described estimation parameter. Here, an estimation parameter can be calculated only from the measurement data, and thus, the performance indicator is not essential. If no performance indicator is used, the performance indicator calculator 102 is not essential.

The measurement data storage 103 stores the measurement data from the measurement data collector 101 and the performance indicator from the performance indicator calculator 102. The stored measurement data and performance indicator are used when the probability density distribution estimator 105 performs processing.

The simulator 104 performs a simulation of the diagnosis-object system according to an instruction from the probability density distribution estimator 105. It is assumed that a content and method of computation by the simulator 104 are determined in advance by, e.g., a model formula (state equation). Parameters necessary for simulation are provided from the probability density distribution estimator 105. Here, for the simulator 104, an existing simulator may be used.

The probability density distribution estimator 105 (estimator) simulates a state of the diagnosis object based on the measurement data. Here, a state to be estimated (estimated state) means a state relating to an item that cannot be calculated from the measurement items included in the measurement data. For example, if the diagnosis object is an air-conditioning installation, e.g., a set temperature for air conditioning and a temperature of a room can be measured by the measurement devices 202, but a coefficient of cooling/heating performance (COP) of the air-conditioning installation cannot be calculated unless a thermal characteristic model of the subject building is used. As described above, an estimated state refers to a state relating to an item that cannot be calculated from the measurement data acquired by the probability density distribution estimator 105.

An estimated state may be a state that cannot directly be measured from the diagnosis object, a state that cannot be measured by the measurement devices 202 or a state that can be measured but has not been measured.

Examples of an estimated state include, e.g., heat insulation performance of walls, a coefficient of cooling/heating performance (COP) of an air-conditioning device and an expected amount of heat generated by humans in each room if the diagnosis object is an air-conditioning installation.

Although it is assumed that a state to be estimated and measurement items used for estimation are determined in advance, the state to be estimated and measurement items may be determined according to an instruction from a user via the input circuit 110. Also, there may be one or more states to be estimated and one or more items used for estimation.

As a method of the estimation, Bayesian estimation is used. Where Y is a state measured based on measurement data and X is a state that is not measured (estimated state and non-measured state), estimation of the state X based on the state Y is equivalent to calculating a probability (posterior probability) P(X|Y) of occurrence of the state X in the case where the state Y occurs. Then, the posterior probability P(X|Y) can be expressed by the following expression according to Bayes' theorem.

$$P ( X \vert Y ) = \frac{P ( Y \vert X ) P ( X )}{P ( Y )} \qquad [ Expression 1 ]$$

In Bayesian estimation, in the above expression, X is a random variable and X is a parameter in a probability density function P. Hereinafter, X is referred to as an estimation (non-measurement) parameter. Then, P(X) is a prior probability density distribution of the estimation parameter X, and P(X|Y) is a posterior probability density distribution of the estimation parameter X when the state Y was measured. P(Y) is a prior probability of occurrence of the state Y. P(Y|X) is a posterior probability of provision of Y at the parameter X, which is referred to as “likelihood”.

Furthermore, where Xt is an estimation parameter at a time t (t is a positive real number), Expression 1 can be substituted by the following expression.

$$P ( Xt \vert Y 1 \text{:} t ) = \frac{P ( Yt \vert Xt ) P ( Xt \vert Y 1 \text{:} t - 1 )}{P ( Yt \vert Y 1 \text{:} t - 1 )} \qquad [ Expression 2 ]$$

Y1:t means a set of data measured up to the time t, Y={Y1, Y2, . . . Yt}. In other words, P(Xt|Y1:t) means a probability density distribution of the estimation parameter X based on measurement values from a measurement start time to a current time.

If attention is focused on a distribution shape of the probability density distribution, P(Yt|Y1:t−1) is a constant not depending on X and thus may be ignored. Accordingly, P(Yt|Y1:t−1) can be expressed by the following expression.

P(Xt|Y1:t)∝P(Yt|Xt)P(Xt|Y1:t−1) [Expression 3]

Expression 3 above means that as a result of obtaining a new measurement value Yt and calculating a likelihood P(Yt|Xt), a posterior probability density distribution P(Xt|Y1:t−1) estimated from measurement data up to a previous time t−1 can sequentially be updated to a posterior probability density distribution P(Xt|Y1:t) to be estimated from measurement data up to the current time. Accordingly, starting from an arbitrary initial probability density distribution P(X0) at an initial time t=0, repetition of calculation of the likelihood and update of the posterior probability density distribution enables to obtain the probability density distribution of the estimation parameter X for the current time.

As methods for obtaining a posterior probability density distribution, for example, Markov chain Monte Carlo (MCMC) methods including Gibbs methods and Metropolis methods is known. Also, particle methods which is a kind of sequential Monte Carlo methods is known as the methods for obtaining a posterior probability density distribution.

The probability density distribution estimator 105 calculates a posterior probability density distribution using a predetermined one of the above methods. For calculation of the likelihood P(Yt|Xt), the simulator 104 is used. The estimated posterior probability density distribution is sent to the estimated probability density distribution processor 106.

As an example of the probability density distribution estimator 105 estimating a posterior probability density distribution, a case using a particle filter as an estimation method will be described.

A particle filter is a method in which a posterior probability density distribution P(X|Y) of the estimation parameter X is approximated by a distribution in a particle group including numerous particles. In the particle filter, prediction, likelihood calculation and resampling (update of the distribution of the particles) are sequentially repeated, whereby the posterior probability density distribution of the estimation parameter X for a current time is calculated.

The number of particles may arbitrarily be determined generally within a range of around 100 to 10000. As the total number of particles is larger, the estimation accuracy is enhanced more; however, time required for the estimation calculation becomes longer. Here, where the number of particles is n (n is a positive integer), the particle group is represented by P={p1, p2, . . . , pi . . . pn}. Here, i is an integer that is not smaller than 1 and is not larger than n.

If there is a plurality of states to be estimated, the estimation parameter X can be expressed by an n-dimensional vector X={x1, x2, . . . xm} including m (m is a positive integer) components. For example, where both a COP and an expected heat generation amount per human are estimated, x1 is determined as the COP and x2 is determined as the expected heat generation amount, but other information may be included. Each particle includes all pieces of information that enable calculation of a predictive value and a predictive measurement value Yt+1 of each component of the particle for a time t+1 using random numbers and a predetermined model formula (state equation), with the aforementioned measurement value Yt and the components of the particle as inputs thereto. In this case, an i-th particle can be expressed by the following expression.

pi={x1i,x2i, . . . ,xmi,weight i}

A weight i is a numerical value used in processing in later-described resampling. A value and a weight of each component of a particle can be expressed by a floating point or an integer.

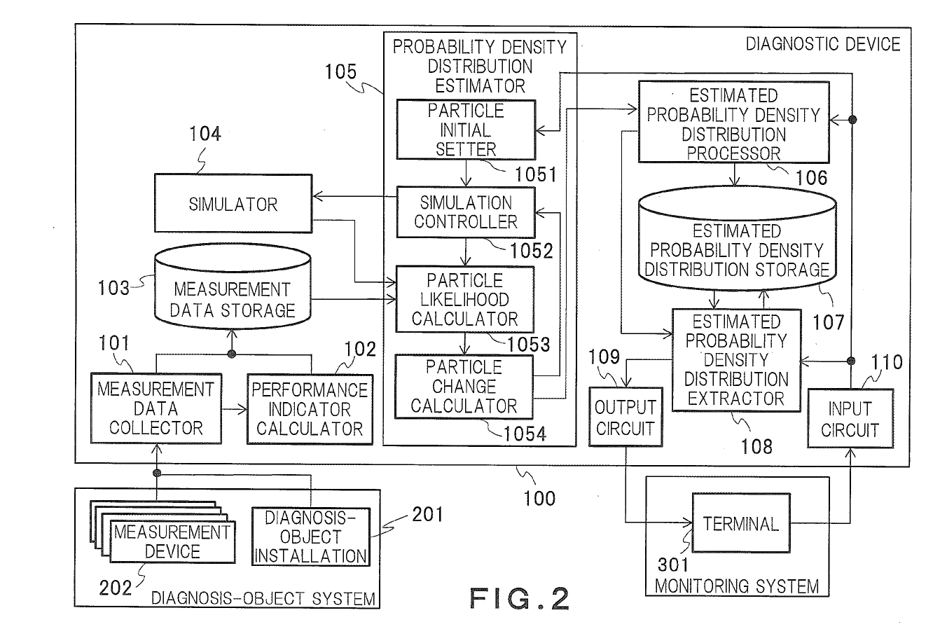

FIG. 2 is a block diagram illustrating an example of a diagnostic device 100 where a particle filter is used. The probability density distribution estimator 105 in this case includes a particle initial setter 1051, a simulation controller 1052, a particle likelihood calculator 1053 and a particle change calculator 1054.

The particle initial setter 1051 sets an initial value of each component and a weight of each particle at an initial time. It is assumed that the initial value of the component is 0 and the initial value of the weight is 1; however, the initial values may be other values. Also, the user may input the values from the input circuit 110.

The simulation controller 1052 sends the values of the components and the weight of each particle to the simulator 104 and provides an instruction to perform a simulation.

The simulator 104 calculates predictive values of the components of each particle for a time t+1 using random numbers and a predetermined model formula (state equation).

The particle likelihood calculator 1053 calculates a likelihood based on a difference between the predictive value of each particle for the time t+1, which has been calculated by the simulator 104, and an actual measurement value of measurement data at the time t+1.

Examples of the method for calculation of the likelihood include, e.g., a method in which a Euclidean distance between a measurement value of measurement data and a predictive value from the simulator 104 is normalized assuming that noise based on a Gaussian distribution is contained in observation values; however, the method is not specifically limited.

The particle change calculator 1054 performs resampling with the likelihood of each particle calculated by the particle likelihood calculator 1053 as a weight value of the particle. Resampling means that each particle is replicated or eliminated based on the weight value to produce a new particle group. Here, the number of particles is constant because a number of particles, the number corresponding to the number of particles eliminated, are replicated.

In a method for resampling, based on a selection probability Ri, which is a value obtained by dividing a weight i of a particle pi by a total sum of weights of all the particles (weight i/Σweight i), each particle is replicated or eliminated. Then, n particles existing after end of the resampling is determined as a new set of particles.

Among values of all the components of all the particles in the new particle group, the particle change calculator 1054 changes a value of each component of particles exist in a section formed in advance by dividing by a regular interval to a predetermined value in the section. This is because a value in the probability density distribution is determined by the number of particles. Then, the weight of each particle is set to 1. As described above, a particle group for the time t+1 is produced.

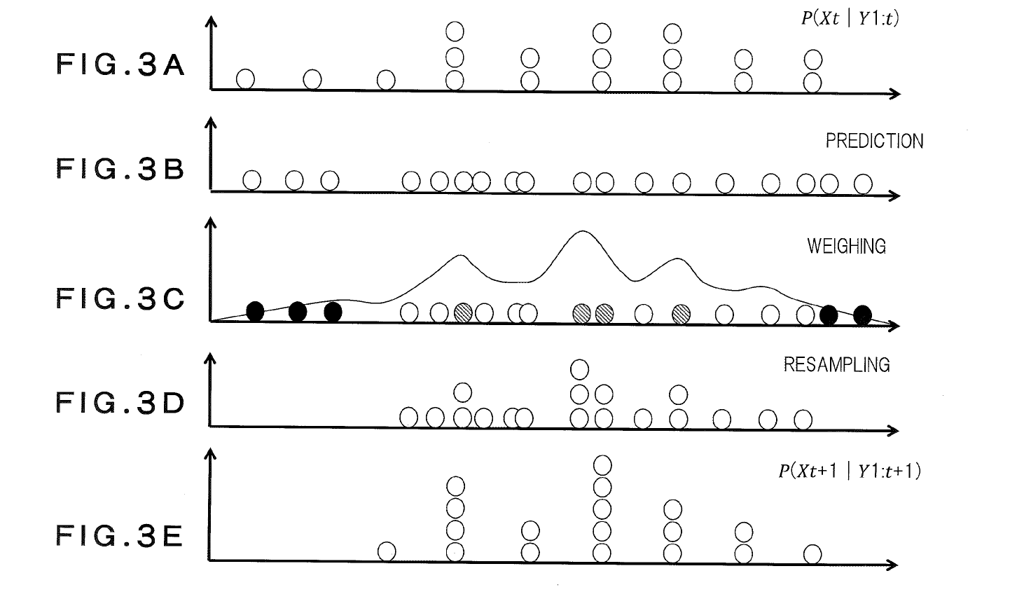

FIGS. 3A to 3E are diagrams illustrating a content of processing in a particle filter. The abscissa axis represents a random variable x1 and the ordinate axis represents a probability density.

FIG. 3A illustrates a distribution of particles at the time t. For sake of simplicity, a particle illustrated above another particle indicates that there is a plurality of particles whose values of x1 are the same.

FIG. 3B is a distribution resulting from a distribution of particles at the time t+1 being predicated by a simulation.

FIG. 3C indicates a likelihood graph and a classification of weights of particles by colors. Based on the magnitude of the likelihood indicated by the curved line, the weight of each particle is determined. A criterion for determining whether the likelihood is large or small is determined in advance. Here, particles having a small likelihood are indicated in black, particles having a large likelihood are indicated by shading, and the other particles are indicated in white.

FIG. 3D illustrates a result of resampling. The particles indicated in black having a small likelihood have been eliminated, and the shaded particles having a large likelihood have been replicated. Here, the counts of replicas of the particles may be different depending on the weights. For example, for a particle having a largest likelihood in FIG. 3C, two replicas are produced in FIG. 3D.

FIG. 3E illustrates a distribution of particles at the time t+1. As a result of adjustment to change all of values of particles in each fixed section to a fixed value, there is a plurality of particles having a same value, providing a shape of the probability density distribution at the time t+10.

This processing is repeated up to the current time, whereby a posterior probability density distribution at the current time can be obtained finally.

The estimated probability density distribution processor 106 adds additional information such as a recording date to the posterior probability density distribution (estimated probability density distribution) calculated by the probability density distribution estimator 105, as an index. The additional information may be acquired from the measurement data or may be acquired from non-illustrated other database.

Also, the estimated probability density distribution processor 106 does not need to consistently process a probability density distribution. For example, additional information may be recorded upon receipt of an instruction from the user via the input circuit 110, at periodic time intervals or during a period in which an irregular event such as an installation replacement plan is underway.

The index is used for search processing by the estimated probability density distribution extractor 108, which will be described later. The index may include, e.g., a date, a time, a weather and a season of the recording, the recording day of the week and arbitrary or multiple-choice keywords for identifying an event affecting the diagnosis object. Any keywords that are used for general database searching can be used.

The event may be, for example, any event that is deemed to affect the diagnosis-object installation such as replacement, inspection or repair of the subject installation or change in layout of the site in which the installation is placed or change of tenants.

Also, the estimated probability density distribution processor 106 may produce an estimated probability density distribution. For example, it is possible that: only values of particles are provided from the particle change calculator; and the estimated probability density distribution processor 106 produces a probability density distribution.

The estimated probability density distribution storage 107 stores the probability density distribution calculated by the probability density distribution estimator 105.

The estimated probability density distribution extractor 108 (selector) detects a past estimated probability density distribution meeting one or more predetermined conditions from past estimated probability density distributions stored in the estimated probability density distribution storage 107. The condition can be, for example, that an amount of difference from an estimated probability density distribution at a current time is not smaller than a threshold value.

A method for calculating an amount of difference, e.g., a Euclidean distance, Kullback-Leibler (KL) divergence or Jensen-Shannon (JS) divergence can be used. As an example, an expression for calculating an amount of difference between discrete probability density distributions P and Q using extended KL divergence is indicated below. Here, i is a positive integer.

$${D}_{u} ( P , Q ) = {\sum }_{i} \{ P ( i ) log \frac{P ( i )}{Q ( i )} + Q ( i ) log \frac{Q ( i )}{P ( i )} \} \qquad [ Expression 4 ]$$

A KL divergence has no symmetry and thus is not a distance, but an extended KL divergence used here has symmetry and thus can be defined as a distance between probability density distributions. It is known that: the extended KL divergence is 0 where the probability density distributions P and Q correspond to each other; and the value is larger as the difference is larger and the extended KL divergence does not have a negative value. The calculation method is not limited to this calculation method.

The condition is not limited to those using a difference amount. For example, those relating to probability density distributions such as peak positions, averages or discretions of the probability density distributions, or may be those relating to measurement data such as hours or a day of measurement of the measurement data or a weather at the time of the measurement. Also, one or more conditions may be employed.

The output circuit 109 outputs a result of the extraction by the estimated probability density distribution extractor 108.

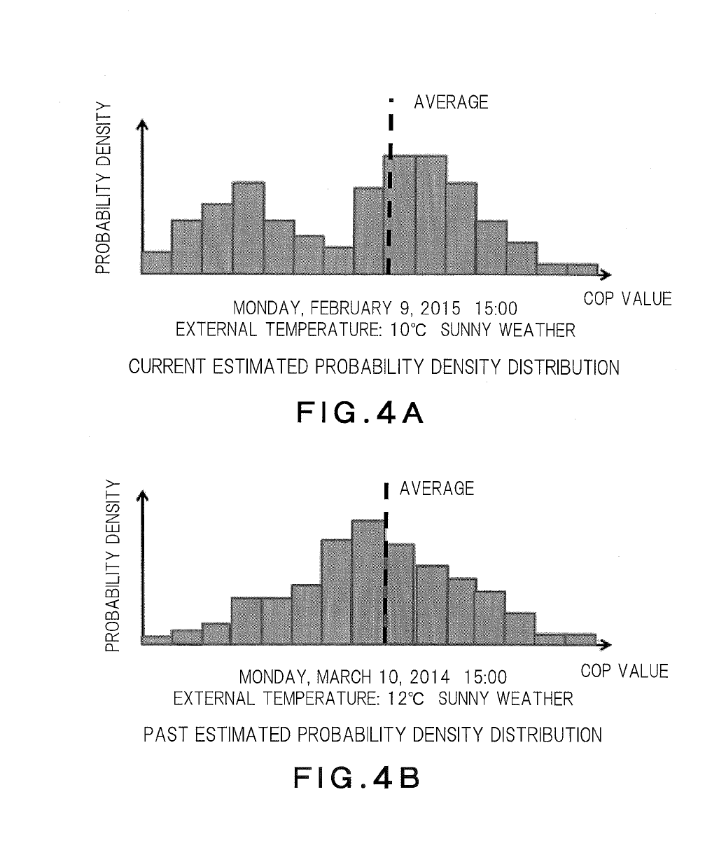

FIGS. 4A and 4B are diagrams each illustrating an example of an output of the output circuit 109. FIG. 4A indicates a current estimated probability density distribution. FIG. 4B indicates a past estimated probability density distribution. The past estimated probability density distribution is extracted based on whether the past status is similar to a current status. In each of the figures, the estimated probability density distribution is indicated together with index information.

As can be seen from FIGS. 4A and 4B, while there are two peaks in FIG. 4A, there is only one peak in FIG. 4B, which is clearly different from FIG. 4A. If the measurement data are represented by numerical values such as averages, both measurement data have values that are nearly equal to each other and are difficult to distinguish from each other. However, indication of the measurement data in the form of probability density distributions makes the difference clear. From the examples in the figures, some possibilities can be detected that: an operation status of the installation has largely changed; and a failure or an abnormality has occurred. As described above, output of estimated probability density distributions assists, e.g., monitoring staff in determining if any abnormality occurs in a diagnosis-object installation or device.

A method of the output may be displaying of the output on a screen or storing the output in, e.g., a file. If there are no estimated probability density distributions having a difference amount that is not smaller than the threshold value, no indication may be provided.

Also, the output circuit 109 outputs a past estimated probability density distribution stored in the estimated probability density distribution storage 107, according to processing by the input circuit 110, which will be described below.

The input circuit 110 receives a search condition designated by the user, and provides an instruction to the estimated probability density distribution extractor 108 so as to search for a parameter probability density distribution stored in the estimated probability density distribution storage 107, the parameter probability density distribution being estimated in the past. Here, it is possible that: the instruction is not given to the estimated probability density distribution extractor 108; and a search-dedicated section may separately be provided. In order to make the user to designate a search condition, a GUI such as a search form may be displayed by the output circuit 109. Here, the output circuit 109 and the input circuit 110 may be integrated as one circuit.

Also, the input circuit 110 may receive instructions from the user to the particle initial setter 1051 and the estimated probability density distribution processor 106. Based on these instructions, the particle initial setter 1051 and the estimated probability density distribution processor 106 may change set values or a content of processing. Also, the input circuit 110 may receive instructions to other sections.

Next, processing performed by the diagnostic device 100 according to the present embodiment will be described. The diagnostic device 100 according to the present embodiment performs three types of processing, i. e., processing relating to measurement data, probability density distribution estimation and output processing, and probability density distribution search processing, which is performed upon receipt of an instruction from the user.

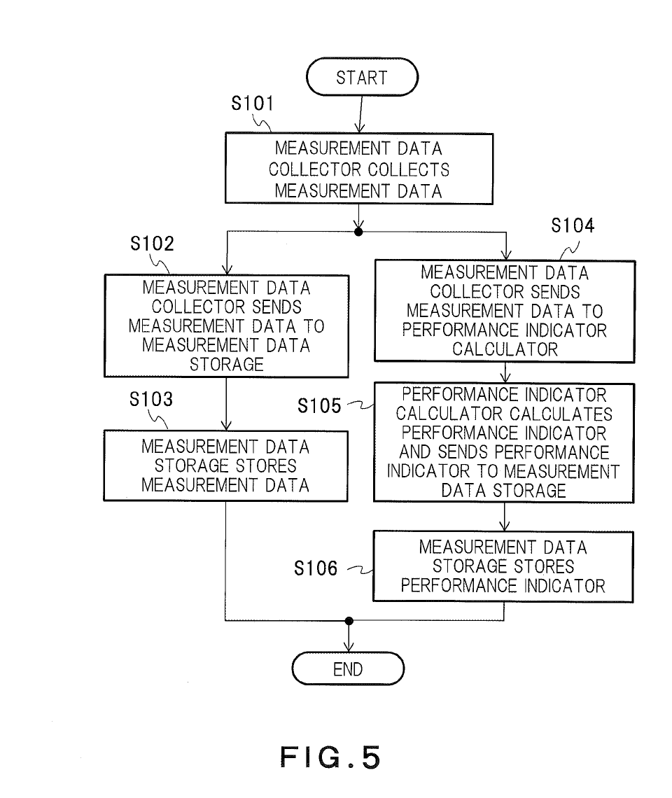

First, the processing relating to measurement data will be described. FIG. 5 is a flowchart of processing relating to measurement data. It is assumed that the processing is started at a timing of, e.g., a preset time, power-on of the diagnostic device 100 or an instruction from the user.

The measurement data collector 101 acquires measurement data from the diagnosis-object installation 201 and the measurement devices 202 in the diagnosis-object system (5101). The measurement data may be acquired from all of the measurement devices 202 or may be acquired from one or more predetermined measurement devices 202. The acquired measurement data may be the entire data or a difference from data acquired before. Also, the acquired measurement data may be only data relating to measurement items used by the probability density distribution estimator 105.

The measurement data collector 101 sends the measurement data to the measurement data storage 103 and the performance indicator calculator 102 (S102 and S104). The sent data may be the entire data or may be only a difference or necessary data.

The measurement data storage 103 stores the acquired data (S103).

The performance indicator calculator 102 calculates a predetermined performance indicator based on the measurement data and sends the predetermined performance indicator to the measurement data storage 103 (S105).

The measurement data storage 103 stores the acquired performance indicator (S106). The processing relating to measurement data ends here.

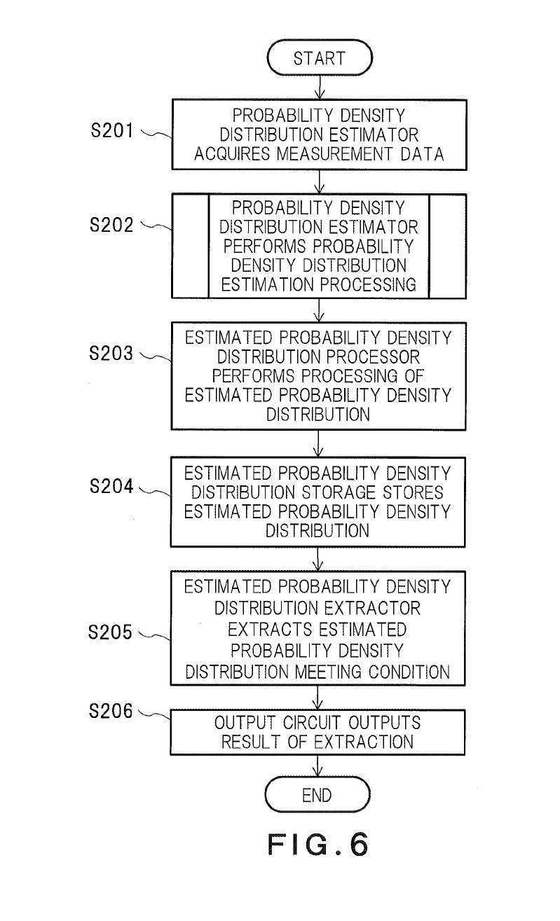

Next, the processing of probability density distribution estimation and output will be described. FIG. 6 is a flowchart of probability density distribution estimation and output processing. It is assumed that the processing is started at a timing of, e.g., storing of the measurement data in the measurement data storage 103, a preset time, power-on of the diagnostic device 100 or an instruction from the user.

The probability density distribution estimator 105 acquires measurement data necessary for the processing from the measurement data storage 103 (S201). The necessary measurement data differs depending on the estimation parameter. The estimation parameter and the necessary measurement data may be determined in advance or may be designated by the user via the input circuit 110. One or more estimation parameters may be employed.

The probability density distribution estimator 105 performs probability density distribution estimation processing based on the measurement data (S202). The processing in S202 will be described later.

The estimated probability density distribution processor 106 performs processing of data of the acquired estimated probability density distribution to, e.g., add an index thereto (S203). Also, the processing may be performed only if an instruction for the processing is received from the user via the input circuit 110.

The estimated probability density distribution storage 107 stores the processed estimated probability density distribution (S204).

The estimated probability density distribution extractor 108 compares the current estimated probability density distribution and past estimated probability density distributions stored in the estimated probability density distribution storage 107 with each other and extracts a past estimated probability density distribution meeting one or more conditions (S205). The current estimated probability density distribution may be received from the estimated probability density distribution processor 106, together with a command for performing processing. Or, it is possible to receive only the index and extract the current estimated probability density distribution from the estimated probability density distribution storage 107. Also, the processing may be performed only if an instruction for extraction is received from the user via the input circuit 110.

The output circuit 109 outputs the past estimated probability density distribution acquired from the estimated probability density distribution extractor 108 and the current estimated probability density distribution (S206). The processing of probability density distribution estimation and output ends here.

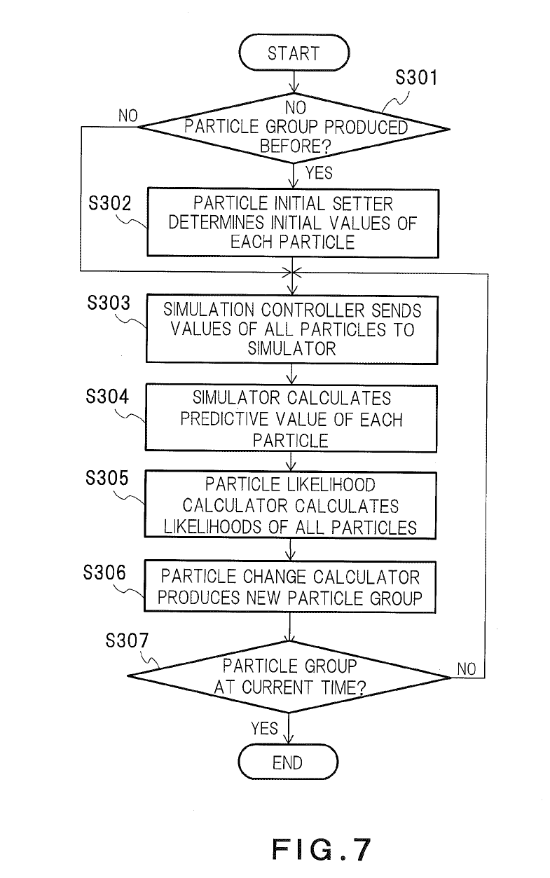

The probability density distribution estimation processing (S202) in the case where a particle filter is used will be described. FIG. 7 is a flowchart of particle filter processing.

For an estimation parameter for which a probability density distribution is produced, the particle initial setter 1051 determines whether or not there is a particle group produced before (S201). If there is, the processing proceeds to the processing in S303. If there is not, the particle initial setter 1051 determines initial values of components of each particle (S302). Although it is assumed that the number of particles is determined in advance, the number of particles may be determined by the particle initial setter 1051 in this step.

The simulation controller 1052 sends the values of components of all the particles to the simulator 104 (S303). The simulator performs simulation for all the acquired particles to calculate a predictive value of each particle for a next time (S304).

The particle likelihood calculator 1053 acquires the predictive values from the simulation controller 1052 and measurement data from the measurement data storage 103 and calculates likelihoods of the respective particles based on the predictive values and the measurement data (S305).

The particle change calculator 1054 performs resampling and adjustment of the values of the respective particles to produce a new particle group (S306). Whether or not the produced new particle group is a particle group at a current time is confirmed (S307), and if the new particle group is not a particle group at the current time (NO in S307), the processing returns to the processing in S303. If the new particle group is a particle group at the current time (YES in S307), the processing ends, the processing of probability density distribution estimation and output proceeds to the processing in S203.

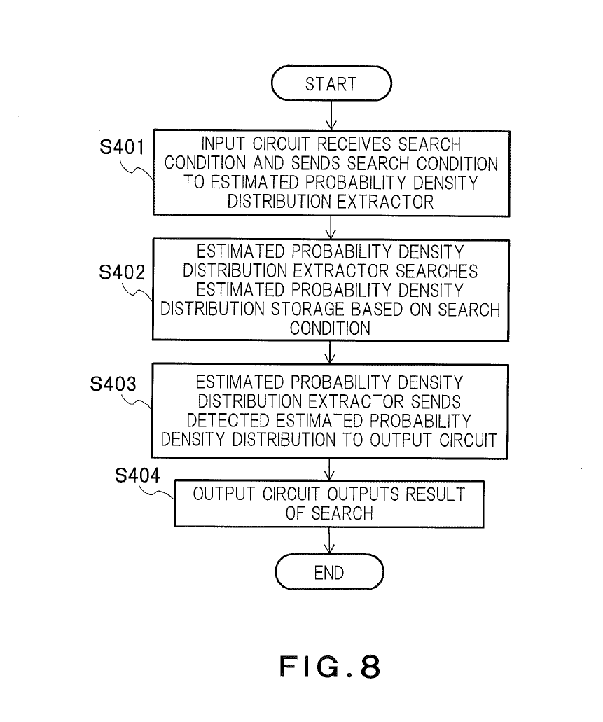

The probability density distribution search processing will be described. FIG. 8 is a flowchart of probability density distribution search processing. The processing is started at a timing of receipt of an input from the user.

The input circuit 110 sends one or more received search conditions to the estimated probability density distribution extractor 108 (S401). In this step, the input circuit 110 may determine properness of the search condition, and if the search condition is improper, provide an instruction to indicate the improperness to the output circuit 109.

The estimated probability density distribution extractor 108 searches the estimated probability density distribution storage 107 based on the acquired search conditions (S402). The estimated probability density distribution extractor 108 sends a detected estimated probability density distribution to the output circuit 109 (S403). If there is no data that can be extracted, the estimated probability density distribution extractor 108 sends that effect to the output circuit 109.

The output circuit 109 outputs a result of the search (S404). An output content may be similar to or different from that in the processing of probability density distribution estimation and output (S206). A plurality of results may be output. The probability density distribution search processing ends here.

As described above, an embodiment of the present invention enables early detection of performance degradation and a failure in an installation or a measurement device. Also, a probability density distribution of a parameter that cannot directly be measured is acquired from measurement data at a current point of time, enabling prevention of cost increase for addition of sensors. Also, since measurement data can be reduced, enabling prevention of increase of stored data and communication traffic. Furthermore, parameter fluctuations are recognized not from fluctuated numerical values but from a graph of a probability density distribution, and thus, an abnormality that could not be recognized from numerical values can be recognized from a shape of the graph, facilitating determination of an abnormality.

Each process in the embodiment described above can be implemented by software (program). Thus, the diagnostic device in the embodiments described above can be implemented using, for example, a general-purpose computer apparatus as basic hardware and causing a processor mounted in the computer apparatus to execute the program.

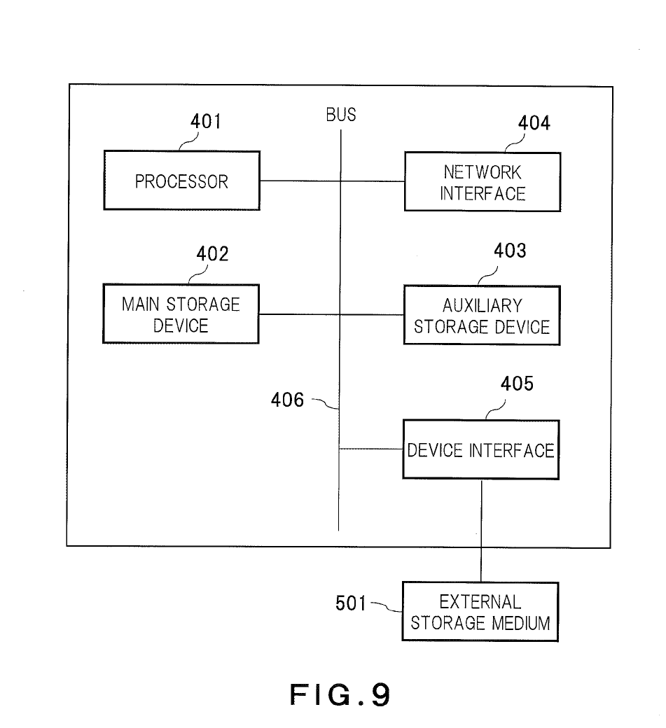

FIG. 9 is a block diagram illustrating an example of a hardware configuration according to an embodiment of the present invention. A diagnostic device 100 can be provided in the form of a computer device including a processor 401, a main storage device 402, an auxiliary storage device 403, a communication device 404 and device interface 405, which are connected via a bus 406.

The processor 401 reads a program from the auxiliary storage device 403 and develops the program in the main storage device 402 and executes the program, whereby functions of the measurement data collector 101, the performance indicator calculator 102, the simulator 104, the probability density distribution estimator 105, the particle initial setter 1051, the simulation controller 1052, the particle likelihood calculator 1053, the particle change calculator 1054, the estimated probability density distribution processor 106, the estimated probability density distribution extractor 108 can be provided.

In the diagnostic device according to the present embodiment, the program to be executed by the diagnostic device may be provided by the program being installed in advance in the computer device or the program being stored in a storage medium such as a CD-ROM or distributed via a network and being installed in the computer device as necessary.

The network interface 404 is an interface for connection with a communication network. Communication with a diagnosis object network and a monitoring system may be provided via the network interface 404. Here, only one network interface is illustrated, but a plurality of network interfaces may be included.

The device interface 405 is an interface to be connected to a device such as an external storage medium 501. The external storage medium 501 may be any record medium such as an HDD, a CD-R, a CD-RW, a DVD-RAM, a DVD-R or a SAN (storage area network). The measurement data storage 103 and the estimated probability density distribution storage 107 may be connected, as the external storage medium 501, to the device interface 405.

The main storage device 402 is a memory device that temporarily stores, e.g., a command to be executed by the processor 401 and various data, and may be a volatile memory such as a DRAM or a non-volatile memory such as an MRAM. The auxiliary storage device 403 is a storage device that permanently stores, e.g., programs and data, and is, for example, an HDD or an SSD. Data retained in, e.g., the measurement data storage 103 and the estimated probability density distribution storage 107 are stored in the main storage device 402, the auxiliary storage device 403 or the external storage medium.

The terms used in each embodiment should be interpreted broadly. For example, the term “processor” may encompass a general purpose processor, a central processor (CPU), a microprocessor, a digital signal processor (DSP), a controller, a microcontroller, a state machine, and so on. According to circumstances, a “processor” may refer to an application specific integrated circuit (ASIC), a field programmable gate array (FPGA), and a programmable logic device (PLD), etc. The term “processor” may refer to a combination of processing devices such as a plurality of microprocessors, a combination of a DSP and a microprocessor, one or more microprocessors in conjunction with a DSP core.

As another example, the term “memory” may encompass any electronic component which can store electronic information. The “memory” may refer to various types of media such as random access memory (RAM), read-only memory (ROM), programmable read-only memory (PROM), erasable programmable read only memory (EPROM), electrically erasable PROM (EEPROM), non-volatile random access memory (NVRAM), flash memory, magnetic or optical data storage, which are readable by a processor. It can be said that the memory electronically communicates with a processor if the processor read and/or write information for the memory. The memory may be integrated to a processor and also in this case, it can be said that the memory electronically communication with the processor.

The term “storage” may generally encompass any device which can memorize data permanently by utilizing magnetic technology, optical technology or non-volatile memory such as an HDD, an optical disc or SSD.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A diagnostic device, comprising:
an estimator, for each of a plurality of times, estimating a probability density distribution of a parameter representing a state of a diagnosis object, based on a measurement value of the diagnosis object, the measurement value being measured up to each of the times; and
a selector selecting one or more probability density distributions meeting a predetermined condition relating to the probability density distribution.

2. The diagnostic device according to claim 1, further comprising a estimated probability density distribution processor adding an index to the probability density distribution for each of the times, the probability density distribution being estimated by the estimator,
wherein the selector selects one or more probability density distributions based on the index.

3. The diagnostic device according to claim 1, wherein the estimator estimates a new probability density distribution based on a probability density distribution at a first time and a likelihood calculated based on a measurement value after the first time.

4. The diagnostic device according to claim 1, wherein the estimator estimates the probability density distribution using a particle filter.

5. The diagnostic device according to claim 1, wherein the condition is that a difference between the probability density distribution selected by the selector and the probability density distribution calculated by the estimator is not larger than a predetermined threshold value.

6. The diagnostic device according to claim 5, wherein the difference is calculated based on Kullback-Leibler divergence or extended Kullback-Leibler divergence.

7. The diagnostic device according to claim 1, further comprising an output circuit outputting at least any one of the probability density distributions estimated by the estimator and the probability density distributions selected by the selector.

8. The diagnostic device according to claim 2, further comprising an output circuit outputting at least any one of the probability density distributions estimated by the estimator and the probability density distributions selected by the selector; and
the index includes a date and a time of measurement of the measurement value or a content of the measurement value; and
information output by the output circuit includes the index.

9. The diagnostic device according to claim 7, further comprising an input circuit receiving an input from a user, wherein:
based on a search condition from the input circuit, the selector selects one or more probability density distributions meeting the search condition; and
the output circuit outputs at least any one of the selected probability density distributions.

10. An estimation method for making a computer perform:
estimating, for each of a plurality of times, a probability density distribution of a parameter representing a state of a diagnosis object based on a measurement value of the diagnosis object, the measurement value being measured up to each of the times; and
selecting one or more probability density distributions meeting a predetermined condition relating to the probability density distribution.

11. A non-transitory computer readable medium having a computer program stored therein which causes a computer when executed by the computer, to perform processes comprising:
estimating, for each of a plurality of times, a probability density distribution of a parameter representing a state of a diagnosis object based on a measurement value of the diagnosis object, the measurement value being measured up to each of the times; and
selecting one or more probability density distributions meeting a predetermined condition relating to the probability density distribution.

12. A diagnostic system comprising a diagnosis object, a first communication device, a second communication device and a third communication device, wherein:
the first communication device sends a measurement value of the diagnosis object to the second communication device;
the second communication device includes
an estimator, for each of a plurality of times, estimating a probability density distribution of a parameter representing a state of the diagnosis object, based on the measurement value of the diagnosis object, the measurement value being measured up to each of the times,
a selector selecting one or more probability density distributions meeting a predetermined condition relating to the probability density distribution, and
an output circuit that outputting at least any one of the probability density distributions estimated by the estimator and the probability density distributions selected by the selector; and
the third communication device receives the output from the output circuit.
